(19) United States
(12) Patent Application Publication
(10) Pub. No.: US 2009/0175117 A1
(43) Pub. Date: Jul. 9, 2009

(54) Conveying screw member for plastic granule cutting and transporting mechanism

(76) Inventor: Chun-Jung Lin, Tainan County (TW)

Correspondence Address: Lin, Chun-Jung, No.2, Alley 492, Hai Tien, Rd., Sec.2, TAINAN, 709, TW

(21) Appl. No.: 12/006,425

(22) Filed: Jan. 3, 2008

(51) Int. Cl. B01F 7/00

(52) U.S. Cl. 366/83

(57) ABSTRACT

A conveying screw member for a plastic granule cutting and transporting mechanism includes a plastic granule collector, a heating conduit, a conveying screw, a plastic granule molding structure and a power transmission device. The plastic granule collector is a hollow cylinder which has an outlet being positioned thereon. The heating conduit is a longitudinal hollow tube which has a round hole being respectively positioned at both ends. The conveying screw member which has the conveying screw being set thereon, and the reversing screws and two supporting bases being respectively set at both ends is installed in the heating conduit. The plastic granule molding structure is equipped near the edge of the end of the heating conduit. The power transmission device is installed near the plastic granule collector and attached to the supporting base of one end of the conveying screw member.

### BACKROUND OF THE PRESENT INVENTION

1. Field of the Invention

The present invention relates to a conveying screw member, particularly a device that being equipped in the plastic granules cutting and transporting mechanism.

2. Description of the Related Arts

As shown in FIG. 5 of the prior art, the conventional plastic granule cutting and transporting mechanism is designed to include a conveying screw member (60) supported against only single end of a supporting base (63) which is equipped with a power transmission device (65) therein. On the end of the supporting base (63) side of the conveying screw member (60), there is a reversing screw (62) and a plastic granule molding structure (64) on another end. But such design has the following disadvantages.

First, supporting on only single end may easily cause damage to the supporting base (63) for the shaking problem took place on the end when the conveying screw member (60) spins.

Second, since the conveying screw member (60) is supported against only one end and connected with the plastic granule molding structure (64) on another end, the cooling pipe needs to be stretched into the conveying screw member (60) from the supporting base section; however, the cooling effect has been decreased during the process of stretching from one end to another.

Third, since the conveying screw is supported against one end and connected to the plastic granule molding structure on another end, the molding structure needs to be detached when drawing out the conveying screw member (60) for maintenance which may result the problem of inconvenience.

### SUMMARY OF THE PRESENT INVENTION

Please refer to FIGS. 1, 2, 3 and 4, the inventors has improved the design in view of the shortcomings of the prior art. The present invention is a new structure of conveying screw member for plastic granule cutting and transporting mechanism which mainly includes a plastic granules collector, a heat conduit, a conveying screw, a plastic granule molding structure and a power transmission device. The advantages are as following.

First, both ends of the conveying screw member are respectively equipped with a supporting base which one end is equipped within the power transmission device while another is equipped within the ball bearing unit which may decrease the damage to the machine by maintaining steady when the conveying screw spins.

Second, the plastic granules output and the plastic molding structure are installed at the edge of both ends of the heating conduit, therefore the cooling pipe can simultaneously be stretched into both ends of the conveying screw member to accelerate and improve the cooling effect.

Third, since the output and the plastic granule molding structure are installed at the edge of both ends of the conveying screw member, the conveying screw member can be drew out by simply detaching the ball bearing unit instead of the entire molding structure.

### BRIEF DESCRIPTION OF THE DRAWINGS

FIG. 1 is a perspective view from the top of the present invention in 3-dimensional drawing.

FIG. 2 is a side perspective view of the present invention in 3-dimensional drawing.

FIG. 3 is the perspective drawing of detaching the conveying screw member.

FIG. 4 is the perspective drawing of the ball bearing unit.

FIG. 5 is the perspective view of the prior art.

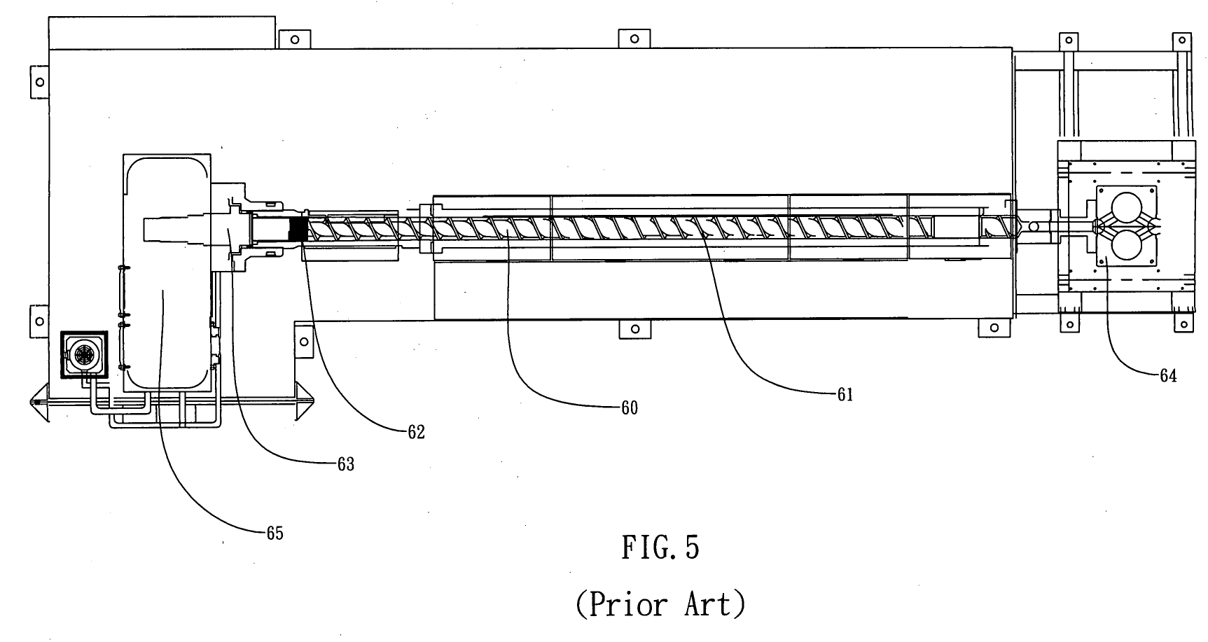

### DETAILED DESCRIPTION OF THE PRESENT INVENTION

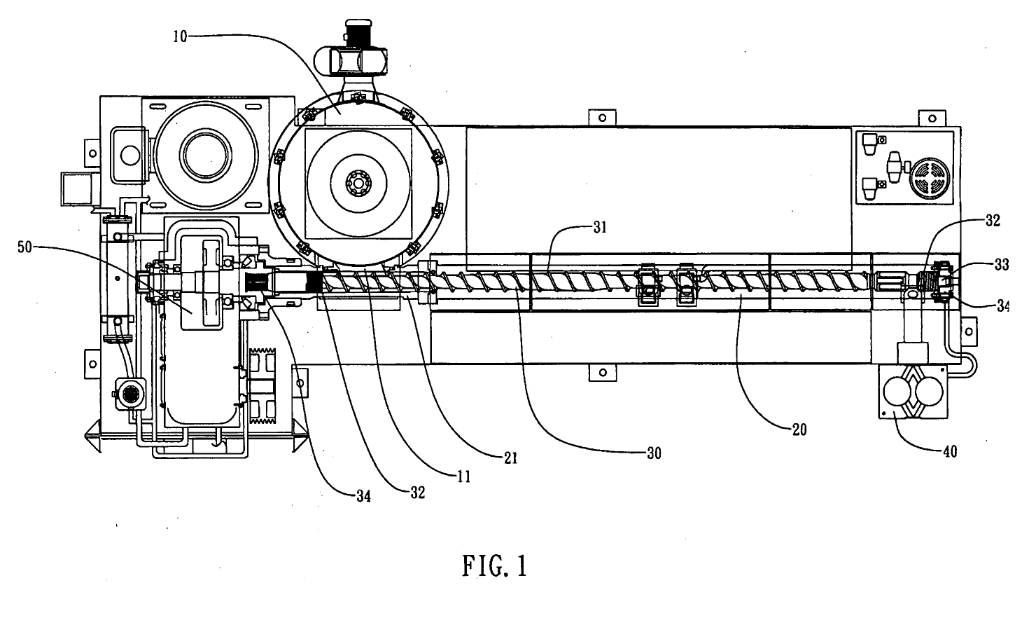

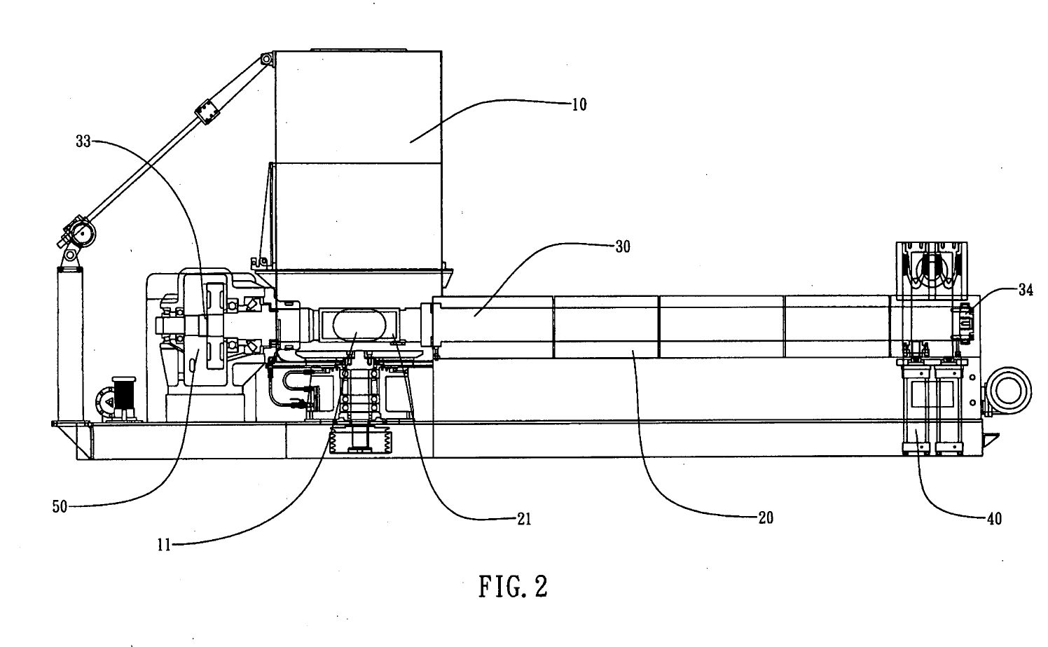

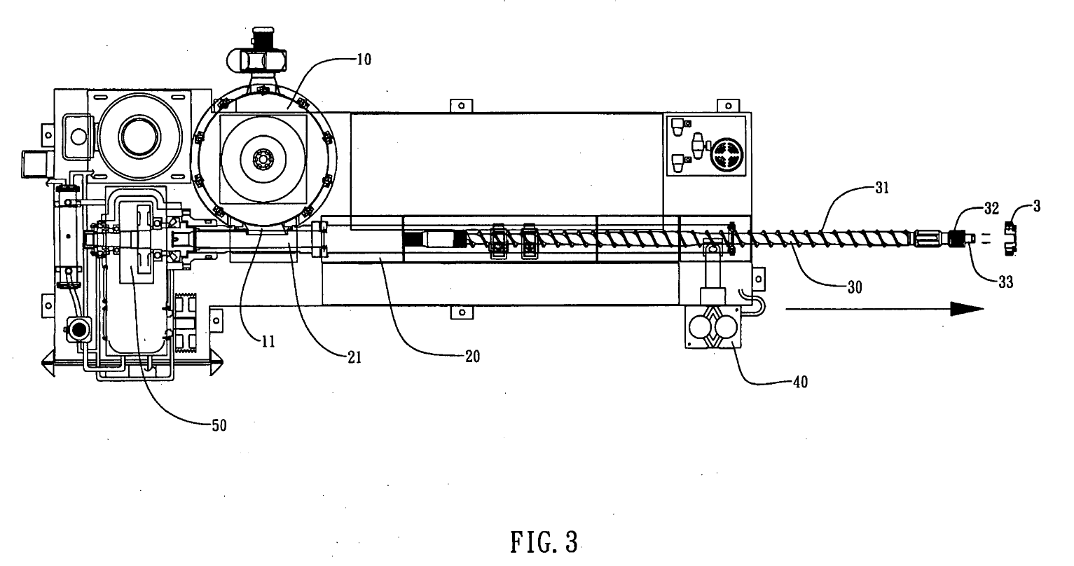

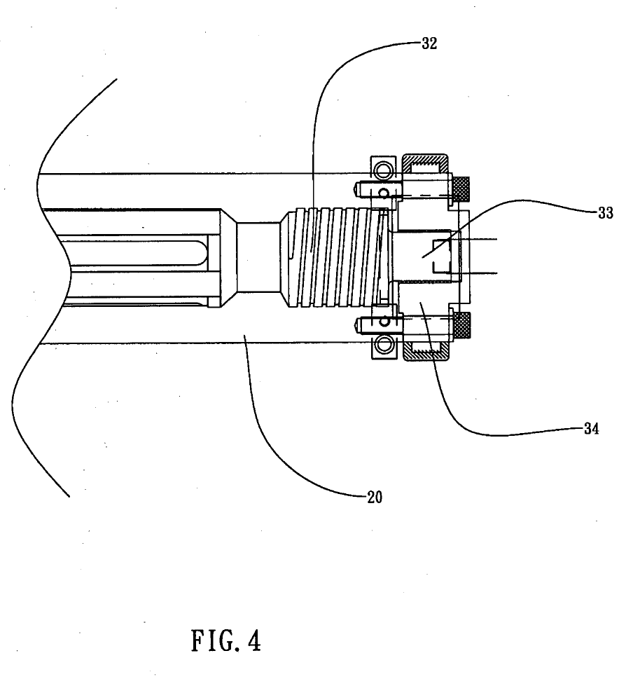

Please refer to FIGS. 1 through 4, in which the conveying screw member for plastic grain cutting and transporting mechanism of the present invention is shown. The present invention comprises a plastic granule collector (10), a heating conduit (20), a conveying screw member (30), a plastic granule molding structure (40) and a power transmission device (50). The plastic granule collector (10) which is a hollow cylinder with an output positioned thereon is used for containing and cutting the plastic granules which are sent into the transporting tube (21) from the outlet (11) and entering the heating conduit (20) afterward.

The heating conduit (20) which is a hollow tube and respectively equipped with a round hole at both ends for the conveying screw (30) extending therefrom is used for melting the plastic granules.

The conveying screw member (30) installed inside the heating conduit (20) which is a hollow long tube allows two cooling pipes extending from both ends to cool the conveying screw member (30) of which the conveying screw (31) is positioned thereon and the reversing screw (32) is positioned at both ends thereof. Both ends of the conveying screw member (30) are respectively installed with a supporting base (33), one of which is engaged with the power transmission device (50) while another one near the plastic granule molding structure (40) is engaged with the ball bearing unit (34) which serves to prevent the conveying screw member (30) from accidentally falling apart. The conveying screws (31) serve to carry the plastic granules forward when the conveying screw member (30) spins; meanwhile, the reversing screws (32) serve to carry the plastic granules which are pushed toward both ends backward.

The plastic granule molding structure (40) which is equipped near the edge of the end of the heating conduit (20) serves to melt and form the plastic material.

The power transmission device (50) which is engaged with the supporting base (33) serves to produce the power to spin the conveying screw member (30) carrying the plastic granules into the heating conduit (20) for being melted and entering the plastic granule molding structure (40) from the outlet of the heating conduit (20) for formation.

When it comes to maintaining the conveying screw member (30), what is needed to be done is to detach the ball bearing unit (34) engaged with the end of the conveying screw member (30) and draw out the conveying screw member (30) from the heating conduit (20) which makes the maintenance process more convenient.

What are claimed are:

1. A conveying screw member for a plastic granule cutting and transporting mechanism comprising a plastic granule collector, a heating conduit, a conveying screw member, a plastic granule molding structure and a power transmission device, wherein said plastic granule collector is a hollow cylinder which has an outlet positioned thereon and said heating conduit is a hollow longitudinal tube which has a round hole respectively positioned at each end; said conveying screw member being installed in said heating conduit, on said conveying screw member being positioned with conveying screws, at the end of said conveying screw member being respectively equipped with a reversing screw and a supporting base; said plastic granule molding structure being installed at the end of side edge of said heating conduit; said power transmission device being positioned near said plastic granule collector; said supporting base positioned on one side of said conveying screw member being installed in said power transmission device and said supporting base positioned on another side of said conveying screw member being installed in a ball bearing unit to achieve the supporting function for each ends of said conveying screw member.

2. A conveying screw member for a plastic granule cutting and transporting mechanism as claimed in claim 1, wherein said conveying screw member is hollow inside the tube for a cooling pipe stretching into from both ends to achieve cooling effect.

3. A conveying screw member for a plastic granule cutting and transporting mechanism as claimed in claim 1, wherein said reversing screws positioned at two ends of said conveying screw member serve to carry the plastic material backward when they are pushed toward both ends.
